(19) United States
(12) Patent Application Publication
(10) Pub. No.: US 2002/0003214 A1
(43) Pub. Date: Jan. 10, 2002

(54) FILTERED PHOTOCONTROLLER

(76) Inventors: JOSEPH F. MORRISSEY JR., ROCKLAND, MA (US); JEFFREY WALTERS, MARSHFIELD, MA (US)

Correspondence Address: IANDIORIO & TESKA, 260 BEAR HILL ROAD, WALTHAM, MA, 02154

(21) Appl. No.: 09/121,382

(22) Filed: Jul. 23, 1998

(51) Int. Cl. G01J 5/20

(52) U.S. Cl. 250/338.4

(57) ABSTRACT

A filtered photocontroller with a housing including a window portion; a circuit board within the housing including a light sensor behind the window portion of the housing; and a polymer filter which attenuates infrared radiation in front of the light sensor for improving the responsiveness of the photocontroller.

### FIELD OF INVENTION

This invention relates to a filtered photocontroller with improved responsiveness for street lights and other electrical devices.

### BACKGROUND OF INVENTION

Photocontrollers are devices that automatically turn electrical devices on and off in response to the ambient light level. They are used on street lights to automatically turn them off during the day and on at night. They are used on billboard lighting systems to turn the billboard lights on early at night, off late at night during periods of low vehicular traffic, on again during early morning rush hour periods when high traffic levels resume, and then off during the daylight hours. Photocontrollers are also used in reverse, for example, to turn a golf course water fountain on during the day and off at night.

Typical photocontrollers use photosensors as a means to detect the ambient light level. Two common photosensors are cadmium sulphide (CdS) cells and silicon junction devices (hereinafter “silicon sensors”).

Although the spectral response of CdS cells closely approximates the spectral response of a human eye, CdS cells tend to drift suffering an irreversible change toward lower sensitivities and thus higher control turn on and off points. This drift towards lower sensitivities is accelerated by overheating. CdS cells also deteriorate rapidly in areas of high humidity, salt spray, or acidic air pollution again causing a drift toward longer burning hours caused by an earlier turn on and later turn off times. Accordingly, CdS cells must be sealed to protect them resulting in higher cost photocontrollers. CdS cells also raise a potential disposal issue because of perceived cadmium hazards. Because of low initial cost and long history of use and human eye spectral response, CdS is the most widely used light sensor for photocontrols.

Silicon sensors are stable under extreme conditions and are fairly small and inexpensive. Thus, silicon sensors are preferred in some part of the photocontroller industry.

Silicon sensors, however, suffer from a serious shortcoming: they are extremely sensitive to infrared radiation and red light and yet insensitive to the blue and green portions of the light spectrum.

This limitation of silicon sensors causes day to day wandering of turn-on and turn-off times corresponding to variations in the red content of light at both sunset and sunrise. For example, a silicon sensor that turns on at one footcandle (10.8 lux) on a clear night may turn on at 3 or 4 footcandles (32.3-43.0 lux) the next night as the weather changes to cloudy. The same is true in reverse for turn off times.

In general, then, since the spectral response of silicon sensors does not match the spectral response of the human eye, a photocontroller with a silicon sensor will not always turn a street light on and off when required causing a potential vehicle and pedestrian safety traffic hazard on high infrared radiation nights and mornings. That is, on a morning with a high infrared content of radiation versus visible light, the photocontroller “sees” the infrared radiation at sunrise and turns the light off too early. On cloudy days, the clouds attenuate visible but attenuate the infrared radiation at a higher level. As a result, the lights are turned on too early wasting electricity. On nights that have a bright red sunset, the silicon sensor “sees” the high infrared radiation and turns the lights on too late. This causes a safety issue.

Heretofore, the only potential solution was the use of an infrared blocking optical filter made of glass to be placed in front of the silicon sensor to reduce its sensitivity to infrared radiation. This potential solution was never realized, however, because of the cost of glass filters. Typical photocontrollers are sold for about $5.00-$6.00. The cost of the glass filter alone was more than $10.00. In addition, previous glass filters, like KG-1 or BG-3 had to be 0.25″ or more thick to accomplish the desired filtering. The result was a heavy and difficult to mount filter. Therefore, to date, the problems associated with silicon sensor based photocontrollers have not been solved and the expensive glass filters are only used (and re-used) to calibrate the photocontrollers prior to shipment. Because of their high cost, glass filters are not integrated into the actual photocontrollers shipped to customers.

### SUMMARY OF INVENTION

It is therefore an object of this invention to provide a photocontroller with an inexpensive filter which blocks infrared radiation.

It is a further object of this invention to provide such a filtered photocontroller that reduces potential vehicle and pedestrian safety traffic hazards on evenings and mornings with high infrared radiation and wasted energy on cloudy evenings and mornings.

It is a further object of this invention to provide such a filtered photocontroller which facilitates the use of low cost and yet stable silicon photosensors.

It is a further object of this invention to provide such a filtered photocontroller which does not unduly increase the cost of the photocontroller.

This invention results from the realization that a photocontroller which preferably incorporates a rugged and stable silicon sensor can be improved at a very low cost by placing a unique polymer filter in front of the silicon sensor to attenuate infrared radiation thereby improving the responsiveness of the photocontroller resulting in improved vehicular and pedestrian traffic safety since the responsiveness of the photocontroller now matches the response of the human eye to sunlight.

This invention features a filtered photocontroller comprising a housing including a window portion; a circuit board within the housing including a light sensor behind the window portion of the housing; and a polymer filter which attenuates infrared radiation in front of the light sensor for improving the responsiveness of the photocontroller.

The light sensor is typically a silicon photosensor. The housing includes a base with a pair of upstanding legs proximate the light sensor forming a channel for holding the polymer filter. Alternatively, the polymer filter is integral with the window portion of the housing. The window usually includes a sheet of acrylic material. The preferred housing is an ANSI C136.10 standard housing.

The polymer filter preferably transmits about 70% of radiation between about 510 nm and 570 nm and less than 20% of infrared radiation below about 450 nm and above 740 nm.

The polymer filter may be a thin sheet or a molded structure. One such molded structure includes one surface for receiving the light sensor and one surface in front of the light sensor. Another molded structure is in the form of a cap disposed over the light sensor.

### DISCLOSURE OF PREFERRED EMBODIMENT

Other objects, features and advantages will occur to those skilled in the art from the following description of a preferred embodiment and the accompanying drawings, in which:

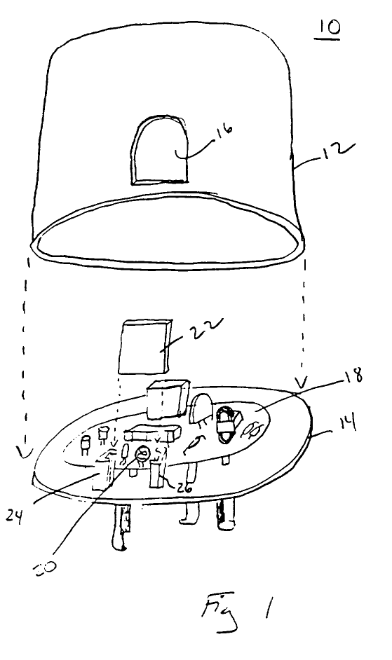

FIG. 1 is a schematic partially exploded view of the filtered photocontroller of the subject invention;

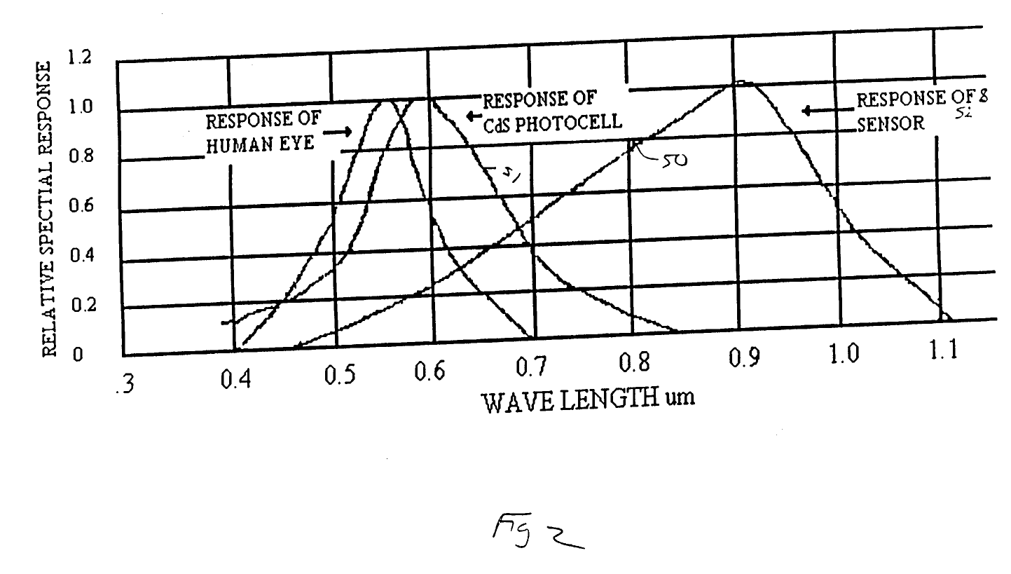

FIG. 2 is a graph showing the response of the human eye, the response of a typical CdS photocell, and the response of a typical silicon sensor to various radiation wavelengths;

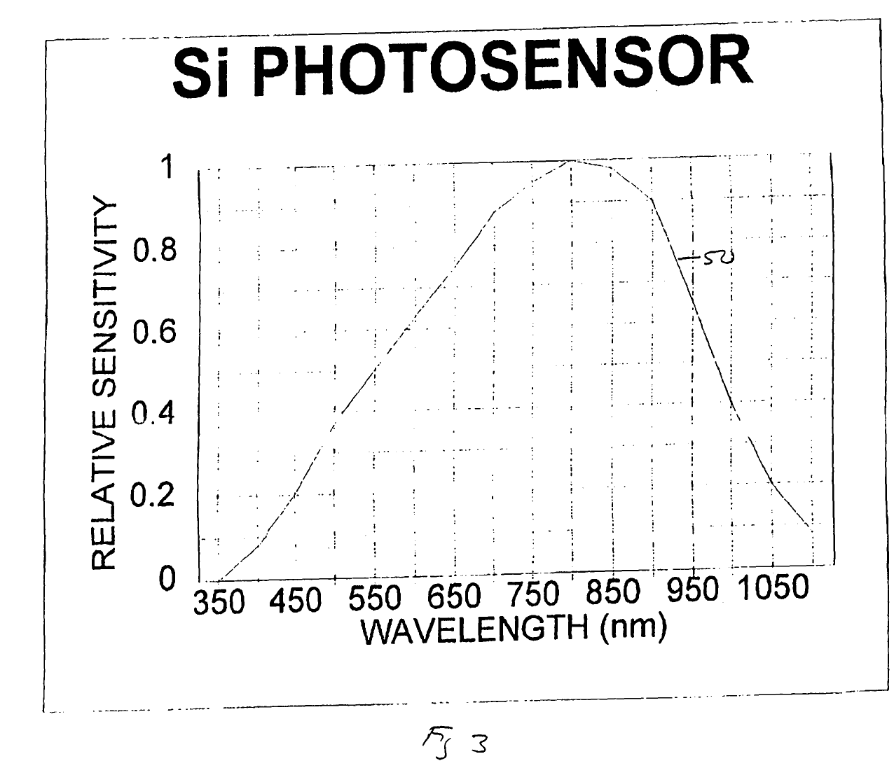

FIG. 3 is a graph showing the relative sensitivity of a typical silicon photosensor based on certain radiation wavelengths;

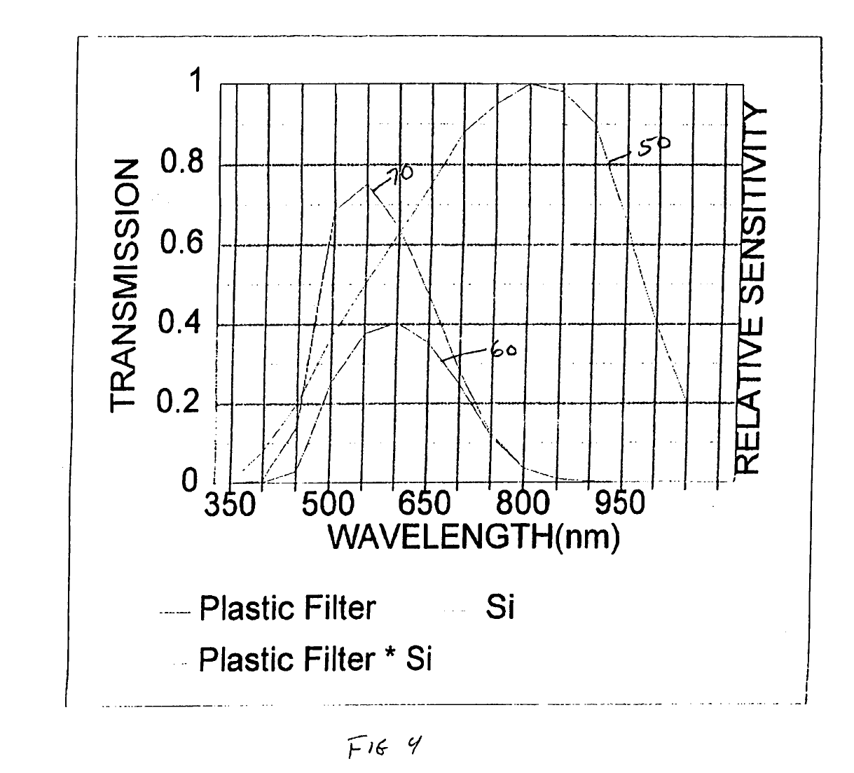

FIG. 4 is a graph showing the relative sensitivity of the filtered silicon sensor in accordance with the subject invention as compared to an unfiltered silicon sensor;

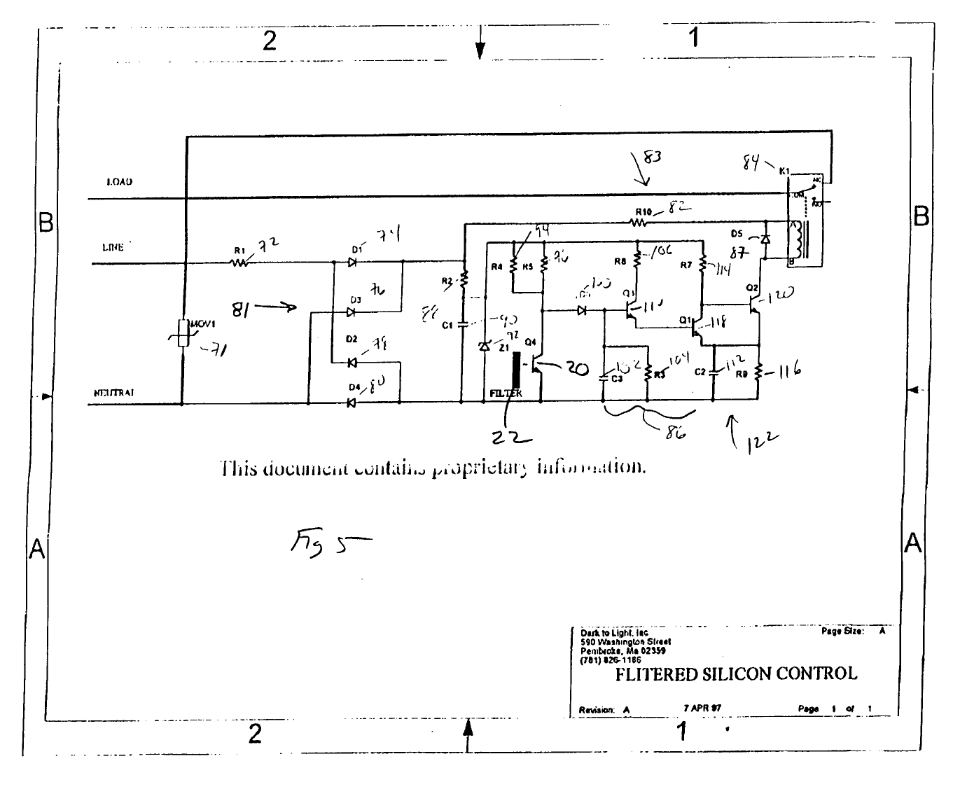

FIG. 5 is a wiring diagram showing the primary components of the circuitry of the filtered photocontroller of this invention; and

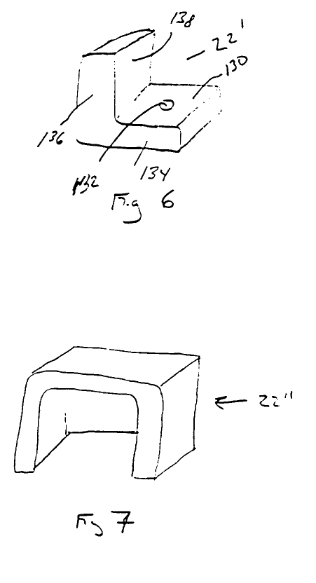

FIGS. 6 and 7 are schematic views of molded filter configuration in accordance with this invention.

Filtered photocontroller 10, FIG. 1, includes housing cap 12 and housing base 14 typically meeting the requirements of ANSI C136.10 standard. In cap 12 is window portion 16 typically made of a clear acrylic material. Another typical housing is the ANSI C136.24 housing. In foreign countries, typical housings made according to the BSI and JIS standards. In some cases, the window is the whole top section of the housing cap.

Circuit board 18 on housing base 14 and covered by housing cap 12 includes the circuitry required to turn the light on at night and off in the day. Included in this circuitry is silicon sensor 20 which is responsive to the ambient light level, and, unfortunately, as discussed in the Background of the Invention above, infrared radiation. The result is that on high infrared radiation mornings when the light should be turned off later than on a clear morning, sensor 20 still “sees” the infrared radiation at sunrise and turns the light off too early. On high infrared radiation evenings, sensor 20 still “sees” the radiation at sunset and turns the light on too late.

In this invention, however, rectangular polymer filter 22 in front of sensor 20 attenuates infrared radiation thereby improving the responsiveness of photocontroller 10 rendering it nearly the same as the responsiveness of the human eye so that photocontroller 10 turns the street light it is connected to on and off at the correct time independent of inelement weather conditions such as cloudy evenings or cloudy mornings or high infrared radiation sunrises or sunsets.

Base portion 14 of the housing preferably includes upstanding legs 24 and 26 forming a C-shaped channel for receiving a rectangular about 0.040 to 0.25″ thick by 1″ to 1¾″ by 1″ sheet of polymer material 22 which filters out infrared radiation. Polymer material 22 is available from Uniroyal Technology Corporation, Glasflex Division, Four Stirling Road, Stirling, N.J. 07980. This material, in a different form, was previously used in goggles to protect a person's eyes from harmful laser or other infrared radiation. For the subject invention, the previous material was modified by Uniroyal as specified by the inventors hereof to develop a material that met the specific infrared absorption characteristics shown in FIG. 4. The previously available Uniroyal material was modified to more closely match the spectral response of a typical KG-1 glass filter and thus to have a peak spectral response (>70%) between 510 nm and 570 nm sloping off quickly so that the spectral response is less than 20% below 450 nm and above 740 nm.

Alternatively, filter 22 could be secured to cover the inside (or outside) of window portion 16 of cap 12 and thus integral with the photocontroller housing. Window portion 16 could include a sheet of acrylic and filter 22 be located behind this sheet of acrylic. Alternatively, the reverse could be true. Filter 22 could also be molded directly into window portion 16 or molded into a support structure placed just in front of or over the sensor.

Silicon sensor 20 unfortunately responds to infrared radiation as shown at 50, FIGS. 2 and 3. The result is a potential vehicle and pedestrian safety traffic hazard on cloudy or high infrared radiation evenings and mornings.

CdS photocells respond more closely to the response of the human eye as shown at 51, FIG. 2 but, unfortunately CdS photocells drift as discussed in the Background of the Invention above.

Filter 22, FIG. 1, however, filters infrared radiation as shown at 60, FIG. 4.

Thus, the combination of silicon sensor 20, FIG. 1, and filter 22 enjoys a more accurate response as shown at 70, FIG. 4. The result is a photocontroller which incorporates the rugged and stable silicon sensor and which has improved responsiveness at a very low cost due to placement of a polymer filter in front of the silicon sensor to attenuate infrared radiation. The result is improved vehicle and pedestrian traffic safety since the responsiveness of the photocontroller now matches the responsiveness of the human eye to sunlight. Filter 22 transmits less than 20% of radiation at or below about 450 nm and above 740 nm as shown in FIG. 4. Filter 22 has a peak transmitting 70% of radiation at about 540 mn.

Photocontroller 10, FIG. 1 thus offers a serious advantage over non-filtered photocontrollers which do not match the spectral response of the human eye and thus will not always turn a street light on and off when required causing a potential vehicular and pedestrian traffic safety hazard on cloudy or high infrared radiation evenings and cloudy mornings. Photocontroller 10, FIG. 1 also offers a serious cost advantage over any attempt to use glass infrared blocking optical filters which would prohibitively increase the cost of the photocontroller.

A photocontroller with a heavy glass filter would cost approximately $15-$16 and the glass filter alone costs about $10. The photocontroller of this invention with the polymer filter costs about $5-$6 and the polymer filter alone costs about $0.10-$0.30. Thus, if 750,000 photocontrollers are sold in a one year period, the cost savings of the subject invention is approximately $7,500,000. In general, the cost of the silicon sensor combined with the cost of the filter is approximately $0.15-$0.35. This cost is similar to the cost of a CdS cell which suffers from the degradation problems discussed in the Background of the Invention above. Thus, the subject invention results in an infrared insensitive photocontroller incorporating a silicon photocell which does not drift or suffer from degradation at approximately the same cost as an infrared insensitive photocontroller with a CdS photocell which does drift. At the same time, the weight of the polymer filter is significantly less than a glass filter and is easier to mount and adhere within the photocontroller than a glass filter. In addition, the polymer filter can be molded into specific shapes easier than a glass filter as discussed inra.

Typical additional components of circuit board 18, FIG. 1, are shown in the block diagram of FIG. 5. MOV1 71 is used for surge suppression caused primarily by lightning. Resistor 72 is a current limiting resistor for the entire controller. Diodes 74, 76, 78 and 80 constitute bridge rectifier 81. Bridge rectifier 81 rectifies the AC line voltage to DC for use by switching circuit 83 and trigger circuit 86. Switching circuit 83 includes resistor 82 which is a current limiting resistor for relay 84. Relay 84 is used to switch the power to the lamp. Diode 87 is used as a backswing diode whose purpose is to suppress the voltage spikes caused by the collapse of the magnetic field in the coil of relay 84. Relay 84 is controlled by trigger circuit 86. Trigger circuit 86 includes resistor 88 which is the current limiting resistor for the trigger circuit. Resistor 88 and capacitor 90 are used to filter out any AC ripple. Zener diode 92 is used as a voltage regulator and secondary surge suppressor. Resistors 94 and 96 are in parallel and are used to calibrate the light level that causes the trigger circuit to be activated. The amount of light that sensor 20 is exposed to determines the amount of current that flows through resistors 94 and 96. As the light increases, more current is allowed to flow through resistors 94 and 96. This causes the voltage drop across the resistors to increase and for the voltage drop across sensor 20 to decrease. When it gets dark, the opposite is true resulting in the voltage level across sensor 20 increasing.

Diode 100, capacitor 102, resistor 104, and resistor 106 make up a time delay feature so that the control does not turn off the lamp in response to extraneous light (e.g. lightning). Capacitor 102 and resistor 104 make up the time constant of the time delay. Block diode 100 prevents the time constant from discharging though sensor 20. Resistor 106 and transistor 110 are used to drive Schmitt trigger circuit 122. Diode 100 also makes time delay unilateral. Capacitor 112, resistor 114, resistor 116, and transistors 118 and 120 make up Schmitt trigger 122. These components could also be implemented with any other device containing a Schmitt trigger such as an integrated circuit.

Filter 22, however, could be used in conjunction with other photocontroller circuit designs including those sold by Dark to Light, 590 Washington Street, Pembroke, Mass. 02359, and other manufacturers. See also U.S. Pat. No. 5,195,016 incorporated herein by this reference.

As discussed above, a heavy and relatively thick glass infrared filter is difficult to mount within a standard photocontroller housing and is not easily molded. As shown in FIG. 1, polymer filter 22 is relatively thin and small and thus easily mounted within photocontroller 10. In addition, the polymer filter material of this invention can be molded resulting in the filter structures shown in FIGS. 6 and 7.

In FIG. 6, filter 22″ includes surface 130 with orifice 132 for receiving the base of a standard silicon sensor therethrough, and leg 134 is secured directly to circuit board 18, FIG. 1. Leg 136 includes surface 138 which is then disposed in front of the silicon sensor.

In FIG. 7, filter 22″ is in the form of a cap which is disposed over the silicon sensor and then mounted to circuit board 18, FIG. 1. Other possible molded configurations are possible.

Therefore, although specific features of this invention are shown in some drawings and not others, this is for convenience only as each feature may be combined with any or all of the other features in accordance with the invention. And, other embodiments will occur to those skilled in the art and are within the following claims:

What is claimed is:

1. A filtered photocontroller comprising:
housing including a window portion;
a circuit board within the housing including a light sensor responsive to infrared radiation behind the window portion of the housing; and
a polymer filter which attenuates infrared radiation disposed in front of the light sensor for improving the responsiveness of the photocontroller.

2. The filtered photocontroller of claim 1 in which the light sensor is a silicon photosensor.

3. The filtered photocontroller of claim 1 in which the housing includes a base with a pair of upstanding legs proximate the light sensor forming a channel for holding the polymer filter.

4. The filtered photocontroller of claim 1 in which the polymer filter is integral with the window portion of the housing.

5. The filtered photocontroller of claim 1 in which the window includes a sheet of acrylic material.

6. The filtered photocontroller of claim 1 in which the housing is an ANSI C136.10 or C136.24 standard housing.

7. The filtered photocontroller of claim 1 in which the polymer filter transmits less than about 70% of radiation between about 510 nm and 570 nm.

8. The filtered photocontroller of claim 1 in which the polymer filter transmits less than about 20% of infrared radiation below about 450 nm and above about 740 nm.

9. The filtered photocontroller of claim 1 in which the polymer filter is a molded structure.

10. The filtered photocontroller of claim 9 in which the molded structure includes one surface for receiving the light sensor and one surface in front of the light sensor.

11. The filtered photocontroller of claim 9 in which the molded structure is in the form of a cap disposed over the light sensor.
